(19) United States
(12) Patent Application Publication
(10) Pub. No.: US 2015/0006581 A1
(43) Pub. Date: Jan. 1, 2015

(54) Method for a Storage Device Accessing a File and Storage Device

(71) Applicant: Huawei Technologies Co., Ltd., Shenzhen (CN)

(72) Inventor: Qingchao Luo, Chengdu (CN)

(21) Appl. No.: 14/489,739

(22) Filed: Sep. 18, 2014

Related U.S. Application Data
(63) Continuation of application No. PCT/CN2013/073383, filed on Mar. 28, 2013.

(51) Int. Cl. G06F 17/30; H04L 29/08; G06F 21/62

(52) U.S. Cl. CPC G06F 17/3007; G06F 21/6218; H04L 67/1097
USPC 707/783

(57) ABSTRACT

A method for a storage device accessing a file and apparatus. A method for a storage device accessing a file, wherein the storage device comprises a memory, wherein the memory stores at least two tables, the method comprises receiving a control instruction of a target user for a target file; acquiring an identifier of metadata stored in the memory by searching a map; acquiring an index number by searching an index table; acquiring one or more permission entries by searching a permission table; identifying a target permission entry which includes the identifier of the target user and a permission of the target user for the target file; determining whether the control instruction is compliant with the permission of the target user for the target file; and executing the control command to the target file.

### CROSS-REFERENCE TO RELATED APPLICATIONS

This application is a continuation of International Application No. PCT/CN2013/073383, filed on Mar. 28, 2013, which is hereby incorporated by reference in its entirety.

### TECHNICAL FIELD

The present invention relates to the computer field, and in particular, to a method for a storage device accessing a file and storage device.

### BACKGROUND

In file-based storage technologies such as network storage or network attached storage (NAS), storage data refers to data stored in the NAS. A manner of permission management for the storage data is to record storage data access permission in metadata of the storage data.

The metadata is data that is used to record storage data attributes such as storage space occupied by data, a data name, and so on. An implementation method of recording the storage data access permission in this manner is: separately creating a permission file, recording management permission that is set by an administrator for the storage data into the separately created permission file, and then recording an address of the permission file in the metadata, where the permission file may be accessed using the address. In this way, the metadata of the storage data, for which the same access permission is set, may correspond to the same access permission file. However, when changing the storage data access permission, it is necessary to create new storage space, create a new permission file, and record an address of the new permission file into the metadata.

The prior art has at least the following technical problems: The number of created permission files is large, which is adverse to permission file management, and, when changing the storage data access permission, it is necessary to create new storage space and create a new permission file, and therefore, an increase of massive permission files makes it more difficult to manage the permission files or even affects the system running speed.

### SUMMARY

Embodiments of the present invention provide a method for a storage device accessing a file and storage device to facilitate management of massive access control permission information and enhance the storage system running efficiency.

To achieve the foregoing objectives, the embodiments of the present invention adopt the following technical solutions:

According to a first aspect, a method for a storage device accessing a file is provided, where a memory stores an index table and a permission table, each index entry in the index table records at least one permission entry index number, and different permission entry index numbers in the same index entry are mapped to different permission entries in the permission table, where metadata of each file includes an entry identifier, and the entry identifier points to an index entry corresponding to the file; each permission entry records a permission entry index number, an access control permission for a file corresponding to the permission entry, and an identifier of a user that has the access control permission, and the different permission entries to which the different permission entry index numbers in the same index entry are mapped to record the access control permission for the same file. The method includes receiving the identifier of the user, a target file identifier, and a control instruction of the user for a target file; obtaining the target file that has the target file identifier, obtaining an entry identifier in metadata of the target file, and further obtaining, from the index table of the memory, an index entry pointed to by the entry identifier in the metadata; obtaining a target permission entry index number in the obtained index entry, where a permission entry pointed to by the target permission entry index number records access control permission for the target file; obtaining, from the permission table according to the target permission entry index number, the permission entries that record the access control permission for the target file, and selecting, from the obtained permission entries, the target permission entry that records the identifier of the user; and determining whether the control instruction is compliant with the access control permission recorded in the target permission entry, and when the control instruction is compliant, executing the control instruction.

With reference to the first aspect, in a first possible implementation manner of the first aspect, the method further includes terminating the control command to the target file, if the control instruction is not compliant with the permission of the target user for the target file.

With reference to the first possible implementation manner of the first aspect, in a second possible implementation manner of the first aspect, the control instruction includes a read instruction, a write instruction, and an execute instruction.

With reference to the first possible implementation manner of the first aspect, in a third possible implementation manner of the first aspect, the method further includes receiving an access control permission modification instruction of the user for the target file; obtaining the target file that has the target file identifier, obtaining the entry identifier in the metadata of the target file, and further obtaining, from the index table of the memory, the index entry pointed to by the entry identifier in the metadata; obtaining the target permission entry index number in the obtained index entry; obtaining, from the permission table according to the target permission entry index number, the permission entries that record the access control permission for the target file, and selecting, from the obtained permission entries, the target permission entry that records the identifier of the user; and modifying, according to the access control permission modification instruction, the access control permission recorded in the target permission entry for the target file.

With reference to the third possible implementation manner of the first aspect, in a fourth possible implementation manner of the first aspect, the modifying the access control permission recorded in the target permission entry for the target file, includes deleting the access control permission of the user for the target file; or adding the access control permission of the user for the target file; where the access control permission includes a read-only permission, a write-only permission, a read-write permission, and an execute permission.

With reference to the third possible implementation manner of the first aspect or the fourth possible implementation manner of the first aspect, in a fifth possible implementation manner of the first aspect, the memory exists on an NAS device or a file sharing server, and the user sends the access control permission modification instruction using a first operating system, where the index table and the permission table corresponding to the first operating system are a first index table and a first permission table respectively, and each first index entry in the first index table records at least one first permission entry index number, where the metadata of each file includes a first entry identifier, the first entry identifier points to a first index entry corresponding to the file in the first operating system, and different first permission entry index numbers in the same first index entry are mapped to different first permission entries in the first permission table; and each first permission entry records a first permission entry index number, first access control permission for the file corresponding to the first permission entry, and an identifier of a user that has the first access control permission, and the different first permission entries to which the different first permission entry index numbers in the same first index entry are mapped to record the first access control permission for the same file. The obtaining the target file that has the target file identifier, obtaining an entry identifier in metadata of the target file, and further obtaining, from the index table of the memory, an index entry pointed to by the entry identifier in the metadata, include obtaining, according to a type of the first operating system, the first index table that matches the type of the first operating system, obtaining the target file that has the target file identifier, obtaining a first entry identifier in the metadata of the target file, and further obtaining, from the first index table, a first index entry pointed to by the first entry identifier in the metadata. The obtaining the target permission entry index number in the obtained index entry includes obtaining a first target permission entry index number in the first index entry, where a first permission entry pointed to by the first target permission entry index number records a first access control permission for the target file. The obtaining, from the permission table according to the target permission entry index number, the permission entries that record the access control permission for the target file, and selecting, from the obtained permission entries, the target permission entry that records the identifier of the user, include obtaining, from the first permission table according to the first target permission entry index number, first permission entries that record the first access control permission for the target file, and selecting, from the obtained first permission entries, a first target permission entry that records the identifier of the user; and the modifying, according to the access control permission modification instruction, the access control permission recorded in the target permission entry for the target file, includes modifying, according to the access control permission modification instruction, the first access control permission recorded in the first target permission entry for the target file.

With reference to the fifth possible implementation manner of the first aspect, in a sixth possible implementation manner of the first aspect, when a user terminal accesses the file using both the first operating system and a second operating system, an index table and a permission table corresponding to the second operating system are a second index table and a second permission table respectively, and each second index entry in the second index table records at least one second permission entry index number, where the metadata of each file includes a second entry identifier. The second entry identifier points to a second index entry corresponding to the file in the second operating system, and different second permission entry index numbers in the same second index entry are mapped to different second permission entries in the second permission table; and each second permission entry records a second permission entry index number, second access control permission for the file corresponding to the second permission entry, and a second identifier of a user that has the second access control permission, and the different second permission entries to which the different second permission entry index numbers in the same second index entry are mapped to record the second access control permission for the same file. After the modifying, according to the access control permission modification instruction, the first access control permission recorded in the first target permission entry for the target file, the method further includes obtaining the second index table that matches a type of the second operating system, obtaining a second entry identifier in the metadata of the target file, and further obtaining, from the second index table, a second index entry pointed to by the second entry identifier in the metadata; obtaining, from a preset user identifier conversion table, the second identifier of the user of the second operating system corresponding to the identifier of the user, where the user identifier conversion table records different identifiers of the same user on different types of operating systems; obtaining a second target permission entry index number in the second index entry, where a second permission entry pointed to by the second target permission entry index number records second access control permission for the target file; obtaining, from the second permission table according to the second target permission entry index number, second permission entries that record the second access control permission for the target file, and selecting, from the obtained second permission entries, a second target permission entry that records the second identifier of the user; and modifying, according to the access control permission modification instruction, the second access control permission recorded in the second target permission entry for the target file, so that the modified second access control permission is the same as the modified first access control permission.

With reference to the first aspect, in a seventh possible implementation manner of the first aspect, when a new child file is added in a computer, the child file inherits a parent file entry identifier owned by its parent file, and the parent file entry identifier points to a parent file index entry so that the child file inherits access control permission for the parent file. The method further includes receiving a new user permission addition instruction and an identifier of a new user sent by a computer administrator for the child file, where the new user permission addition instruction includes access control permission of the new user for the child file; when the new user permission addition instruction is received, adding a new permission entry to the permission table, where the new permission entry includes a new permission entry index number, the access control permission of the new user for the child file, and the identifier of the new user; obtaining the parent file index entry according to the parent file entry identifier; creating a new index entry in the index table, and recording a new entry identifier, the new permission entry index number, and all permission entry index numbers recorded in the parent file index entry into the new index entry; and updating metadata of the child file and the parent file with the new entry identifier, so that the new index entry is found according to the new entry identifier.

According to a second aspect, an access control permission management apparatus is provided, where a memory stores an index table and a permission table, each index entry in the index table records at least one permission entry index number, and different permission entry index numbers in the same index entry are mapped to different permission entries in the permission table, where metadata of each file includes an entry identifier, and the entry identifier points to an index entry corresponding to the file. Each permission entry records a permission entry index number, access control permission for a file corresponding to the permission entry, and an identifier of a user that has the access control permission, and the different permission entries to which the different permission entry index numbers in the same index entry are mapped to record the access control permission for the same file. The apparatus includes a receiving unit configured to receive the identifier of the user, a target file identifier, and a control instruction of the user for a target file; an index entry obtaining unit configured to obtain the target file that has the target file identifier, obtain an entry identifier in metadata of the target file, and further obtain, from the index table of the memory, an index entry pointed to by the entry identifier in the metadata; a permission entry index number obtaining unit configured to obtain a target permission entry index number in the index entry obtained by the index entry obtaining unit, where a permission entry pointed to by the target permission entry index number records access control permission for the target file; a permission entry obtaining unit configured to obtain, from the permission table according to the target permission entry index number obtained by the permission entry index number obtaining unit, permission entries that record the access control permission for the target file, and select, from the obtained permission entries, a target permission entry that records the identifier of the user; a determining unit configured to determine whether the control instruction is compliant with the access control permission recorded in the target permission entry obtained by the permission entry obtaining unit; and an executing unit configured to execute the control instruction when the determining unit determines that the control instruction is compliant with the access control permission recorded in the target permission entry.

With reference to the second aspect, in a first possible implementation manner of the second aspect, the executing unit is further configured to terminate the control instruction when the control instruction is not compliant with the access control permission recorded in the target permission entry.

With reference to the first possible implementation manner of the second aspect, in a second possible implementation manner of the second aspect, the control instruction includes a read instruction, a write instruction, and an execute instruction.

With reference to the first possible implementation manner of the second aspect, in a third possible implementation manner of the second aspect, the receiving unit is further configured to receive an access control permission modification instruction of the user for the target file; and the apparatus further includes a control permission modifying unit configured to modify, according to the access control permission modification instruction, the access control permission recorded in the target permission entry for the target file.

With reference to the third possible implementation manner of the second aspect, in a fourth possible implementation manner of the second aspect, the control permission modifying unit is configured to delete the access control permission of the user for the target file; or add the access control permission of the user for the target file; where the access control permission includes a read-only permission, a write-only permission, a read-write permission, and an execute permission.

With reference to the third possible implementation manner of the second aspect or the fourth possible implementation manner of the second aspect, in a fifth possible implementation manner of the second aspect, the memory exists on an NAS device or a file sharing server, and the user sends the access control permission modification instruction using a first operating system, where an index table and a permission table corresponding to the first operating system are a first index table and a first permission table respectively, and each first index entry in the first index table records at least one first permission entry index number, where the metadata of each file includes a first entry identifier, the first entry identifier points to a first index entry corresponding to the file in the first operating system, and different first permission entry index numbers in the same first index entry are mapped to different first permission entries in the first permission table; and each first permission entry records a first permission entry index number, first access control permission for the file corresponding to the first permission entry, and an identifier of a user that has the first access control permission, and the different first permission entries to which the different first permission entry index numbers in the same first index entry are mapped to record the first access control permission for the same file. The index entry obtaining unit is configured to obtain, according to a type of the first operating system, the first index table that matches the type of the first operating system, obtain the target file that has the target file identifier, obtain a first entry identifier in the metadata of the target file, and further obtain, from the first index table, a first index entry pointed to by the first entry identifier in the metadata; the permission entry index number obtaining unit is configured to obtain a first target permission entry index number in the first index entry, where a first permission entry pointed to by the first target permission entry index number records first access control permission for the target file. The permission entry obtaining unit is configured to obtain, from the first permission table according to the first target permission entry index number, first permission entries that record the first access control permission for the target file, and select, from the obtained first permission entries, a first target permission entry that records the identifier of the user; and the control permission modifying unit is configured to modify, according to the access control permission modification instruction, the first access control permission recorded in the first target permission entry for the target file.

With reference to the fifth possible implementation manner of the second aspect, in a sixth possible implementation manner of the second aspect, when a user accesses the file using both the first operating system and a second operating system, an index table and a permission table corresponding to the second operating system are a second index table and a second permission table respectively, and each second index entry in the second index table records at least one second permission entry index number, where the metadata of each file includes a second entry identifier, the second entry identifier points to a second index entry corresponding to the file in the second operating system, and different second permission entry index numbers in the same second index entry are mapped to different second permission entries in the second permission table; and each second permission entry records a second permission entry index number, second access control permission for the file corresponding to the second permission entry, and a second identifier of a user that has the second access control permission, and the different second permission entries to which the different second permission entry index numbers in the same second index entry are mapped to record the second access control permission for the same file. The apparatus further includes a second index entry obtaining unit configured to after the control permission modifying unit modifies, according to the access control permission modification instruction, the first access control permission recorded in the first target permission entry for the target file, obtain the second index table that matches a type of the second operating system, obtain a second entry identifier in the metadata of the target file, and further obtain, from the second index table, a second index entry pointed to by the second entry identifier in the metadata; a second identifier obtaining unit configured to obtain, from a preset user identifier conversion table, the second identifier of the user of the second operating system corresponding to the identifier of the user, where the user identifier conversion table records different identifiers of the same user on different types of operating systems; a second permission entry index number obtaining unit configured to obtain a second target permission entry index number in the second index entry, where a second permission entry pointed to by the second target permission entry index number records a second access control permission for the target file; a second permission entry obtaining unit configured to obtain, from the second permission table according to the second target permission entry index number, second permission entries that record the second access control permission for the target file, and select, from the obtained second permission entries, a second target permission entry that records the second identifier of the user; and a second control permission modifying unit configured to modify, according to the access control permission modification instruction, the second access control permission recorded in the second target permission entry for the target file, so that the modified second access control permission is the same as the modified first access control permission.

With reference to the second aspect, in a seventh possible implementation manner of the second aspect, when a new child file is added in a computer, the child file inherits a parent file entry identifier owned by its parent file, and the parent file entry identifier points to a parent file index entry so that the child file inherits access control permission for the parent file. The receiving unit is further configured to receive a new user permission addition instruction and an identifier of a new user sent by a computer administrator for the child file, where the new user permission addition instruction includes access control permission of the new user for the child file; the apparatus further includes a permission entry adding unit configured to when the new user permission addition instruction is received, add a new permission entry in the permission table, where the new permission entry includes a new permission entry index number, the access control permission of the new user for the child file, and the identifier of the new user. The index entry obtaining unit is further configured to obtain the parent file index entry according to the parent file entry identifier; the apparatus further includes an index entry adding unit configured to create a new index entry in the index table, and record a new entry identifier, the new permission entry index number, and all permission entry index numbers recorded in the parent file index entry into the new index entry; and a metadata updating unit configured to update metadata of the child file and the parent file with the new entry identifier, so that the new index entry is found according to the new entry identifier.

According to a third aspect, a storage device is provided and includes a communications port configured to receive an identifier of the user, a target file identifier, and a control instruction of the user for a target file; a memory configured to store an index table, a permission table, and code required by a processor for performing operations, where each index entry in the index table records at least one permission entry index number, and different permission entry index numbers in the same index entry are mapped to different permission entries in the permission table, where metadata of each file includes an entry identifier, and the entry identifier points to an index entry corresponding to the file. Each permission entry records a permission entry index number, access control permission for a file corresponding to the permission entry, and an identifier of a user that has the access control permission, and the different permission entries to which the different permission entry index numbers in the same index entry are mapped to record the access control permission for the same file; and the processor configured to obtain the target file that has the target file identifier, obtain an entry identifier in metadata of the target file, and further obtain, from the index table of the memory, an index entry pointed to by the entry identifier in the metadata; where the processor is further configured to obtain a target permission entry index number in the obtained index entry, where a permission entry pointed to by the target permission entry index number records access control permission for the target file; obtain, from the permission table according to the target permission entry index number, permission entries that record the access control permission for the target file, and select, from the obtained permission entries, a target permission entry that records the identifier of the user; and determine whether the control instruction is compliant with the access control permission recorded in the target permission entry, and when the control instruction is compliant, execute the control instruction.

With reference to the third aspect, in a first possible implementation manner of the third aspect, the processor is further configured to terminate the control instruction when the control instruction is not compliant with the access control permission recorded in the target permission entry.

With reference to the first possible implementation manner of the third aspect, in a second possible implementation manner of the third aspect, the control instruction includes a read instruction, a write instruction, and an execute instruction.

With reference to the first possible implementation manner of the third aspect, in a third possible implementation manner of the third aspect, the communications port is further configured to receive an access control permission modification instruction of the user for the target file. The processor is further configured to when the communications port receives the access control permission modification instruction, obtain the target file that has the target file identifier, obtain the entry identifier in the metadata of the target file, and further obtain, from the index table of the memory, the index entry pointed to by the entry identifier in the metadata; obtain the target permission entry index number in the obtained index entry; obtain, from the permission table according to the target permission entry index number, the permission entries that record the access control permission for the target file, and select, from the obtained permission entries, the target permission entry that records the identifier of the user; and modify, according to the access control permission modification instruction, the access control permission recorded in the target permission entry for the target file.

With reference to the third possible implementation manner of the third aspect, in a fourth possible implementation manner of the third aspect, the modifying, by the processor, the access control permission recorded in the target permission entry for the target file, includes deleting the access control permission of the user for the target file; or adding the access control permission of the user for the target file; where the access control permission includes a read-only permission, a write-only permission, a read-write permission, and an execute permission.

With reference to the third possible implementation manner of the third aspect or the fourth possible implementation manner of the third aspect, in a fifth possible implementation manner of the third aspect, the memory exists on an NAS device or a file sharing server, and the user sends the access control permission modification instruction using a first operating system, where an index table and a permission table corresponding to the first operating system are a first index table and a first permission table respectively, and each first index entry in the first index table records at least one first permission entry index number, where the metadata of each file includes a first entry identifier, the first entry identifier points to a first index entry corresponding to the file in the first operating system, and different first permission entry index numbers in the same first index entry are mapped to different first permission entries in the first permission table; and each first permission entry records a first permission entry index number, first access control permission for the file corresponding to the first permission entry, and an identifier of a user that has the first access control permission, and the different first permission entries to which the different first permission entry index numbers in the same first index entry are mapped to record the first access control permission for the same file. The processor is further configured to obtain, according to a type of the first operating system, the first index table that matches the type of the first operating system, obtain the target file that has the target file identifier, obtain a first entry identifier in the metadata of the target file, and further obtain, from the first index table, a first index entry pointed to by the first entry identifier in the metadata; the processor is further configured to obtain a first target permission entry index number in the first index entry, where a first permission entry pointed to by the first target permission entry index number records a first access control permission for the target file; the processor is further configured to obtain, from the first permission table according to the first target permission entry index number, first permission entries that record the first access control permission for the target file, and select, from the obtained first permission entries, a first target permission entry that records the identifier of the user; and the processor is further configured to modify, according to the access control permission modification instruction, the first access control permission recorded in the first target permission entry for the target file.

With reference to the fifth possible implementation manner of the third aspect, in a sixth possible implementation manner of the third aspect, when a user accesses the file using both the first operating system and a second operating system, the index table and the permission table corresponding to the second operating system are a second index table and a second permission table respectively, and each second index entry in the second index table records at least one second permission entry index number, where the metadata of each file includes a second entry identifier, the second entry identifier points to a second index entry corresponding to the file in the second operating system, and different second permission entry index numbers in the same second index entry are mapped to different second permission entries in the second permission table; and each second permission entry records a second permission entry index number, second access control permission for the file corresponding to the second permission entry, and a second identifier of a user that has the second access control permission, and the different second permission entries to which the different second permission entry index numbers in the same second index entry are mapped to record the second access control permission for the same file; after modifying, according to the access control permission modification instruction, the first access control permission recorded in the first target permission entry for the target file, the processor is further configured to obtain the second index table that matches a type of the second operating system, obtain a second entry identifier in the metadata of the target file, and further obtain, from the second index table, a second index entry pointed to by the second entry identifier in the metadata; the processor is further configured to obtain, from a preset user identifier conversion table, the second identifier of the user of the second operating system corresponding to the identifier of the user, where the user identifier conversion table records different identifiers of the same user on different types of operating systems; the processor is further configured to obtain a second target permission entry index number in the second index entry, where a second permission entry pointed to by the second target permission entry index number records second access control permission for the target file; the processor is further configured to obtain, from the second permission table according to the second target permission entry index number, second permission entries that record the second access control permission for the target file, and select, from the obtained second permission entries, a second target permission entry that records the second identifier of the user; and the processor is further configured to modify, according to the access control permission modification instruction, the second access control permission recorded in the second target permission entry for the target file, so that the modified second access control permission is the same as the modified first access control permission.

With reference to the third aspect, in a seventh possible implementation manner of the third aspect, when a new child file is added in a computer, the child file inherits a parent file entry identifier owned by its parent file, and the parent file entry identifier points to a parent file index entry so that the child file inherits access control permission for the parent file; the communications port is further configured to receive a new user permission addition instruction and an identifier of a new user sent by a computer administrator for the child file, where the new user permission addition instruction includes access control permission of the new user for the child file. The processor is further configured to add a new permission entry in the permission table when the communications port receives the new user permission addition instruction, where the new permission entry includes a new permission entry index number, the access control permission of the new user for the child file, and the identifier of the new user; the processor is further configured to obtain the parent file index entry according to the parent file entry identifier; the processor is further configured to create a new index entry in the index table, and record a new entry identifier, the new permission entry index number, and all permission entry index numbers recorded in the parent file index entry into the new index entry; and the processor is further configured to update metadata of the child file and the parent file with the new entry identifier, so that the new index entry is found according to the new entry identifier.

Embodiments of the present invention provide an access control permission management method and apparatus. A computer first receives an identifier of a user, a target file identifier, and a control instruction of the user for a target file, and then obtains, from an index table of a memory, an index entry pointed to by an entry identifier corresponding to the target file identifier; subsequently, obtains a target permission entry index number in the index entry pointed to by the entry identifier corresponding to the target file identifier, and obtains, from a permission table according to the target permission entry index number, permission entries that record access control permission for the target file, and selects, from the obtained permission entries, a target permission entry that records the identifier of the user; and when determining that the control instruction is compliant with the access control permission recorded in the target permission entry, executes the control instruction. Based on the foregoing solutions, the index table and the permission table are used to manage access control permission information, which reduces complexity of managing the access control permission information in the memory and increases the system running speed.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings.

FIG. 1A is a flowchart of a method for a storage device accessing a file according to Embodiment 1 of the present invention;

FIG. 1B is a flowchart of a method for a storage device accessing a file according to Embodiment 2 of the present invention;

FIG. 2 is a flowchart of a method for a storage device accessing a file according to Embodiment 2 of the present invention;

FIG. 3 is a flowchart of a method for a storage device accessing a file according to Embodiment 2 of the present invention;

FIG. 4 is a flowchart of a method for a storage device accessing a file according to Embodiment 2 of the present invention;

FIG. 5 is a block diagram of an access control permission management apparatus according to Embodiment 3 of the present invention;

FIG. 6 is a block diagram of an access control permission management apparatus according to Embodiment 3 of the present invention;

FIG. 7 is a block diagram of an access control permission management apparatus according to Embodiment 3 of the present invention;

FIG. 8 is a block diagram of an access control permission management apparatus according to Embodiment 3 of the present invention;

FIG. 9 is a schematic diagram of a storage device according to Embodiment 3 of the present invention;

FIG. 10 is a schematic diagram of an internal structure that illustrates an index table and a permission table according to Embodiment 1 of the present invention;

FIG. 11 is a schematic diagram of modifying access control permission according to Embodiment 2 of the present invention;

FIG. 12 is a schematic diagram of a user identifier conversion table according to Embodiment 2 of the present invention;

FIG. 13 is a schematic structural diagram of modifying access control permission for a first operating system and a second operating system according to Embodiment 2 of the present invention; and

FIG. 14 is a schematic structural diagram of modifying access control permission for a parent file and a child file according to Embodiment 2 of the present invention.

### DESCRIPTION OF EMBODIMENTS

The following clearly describes the technical solutions in the embodiments of the present invention with reference to the accompanying drawings in the embodiments of the present invention. The described embodiments are merely a part rather than all of the embodiments of the present invention. All other embodiments obtained by a person of ordinary skill in the art based on the embodiments of the present invention shall fall within the protection scope of the present invention.

In a man-machine interaction process between a user and a computer, the user enters instructions into the computer, where the instructions instruct an operating system of the computer to perform corresponding actions. For example, if the user enters a data read instruction, the operating system reads data from a memory and returns it to the user; and if the user enters a data write instruction, the operating system writes the data in the memory and saves it. A location of the writing may be set by the computer by default or specified by the user. The access control permission management method described below according to the embodiments of the present invention is applicable to a computer device. The computer device mentioned herein should include a user interface and a processor, and optionally, a memory may be integrated into the computer device. In this way, the user interface, the processor, and the memory can connect to and communicate with each other using a bus. Of course, in a practical application, the memory may be set as a device that is physically independent of the computer device.

### Embodiment 1

An embodiment of the present invention provides a method for a storage device accessing a file. To implement the method, a memory of a computer system stores an index table and a permission table, and the memory may be the same as or different from a memory for storing files.

The index table is composed of multiple index entries, and each index entry records an entry identifier and at least one permission entry index number. Each permission entry index number is mapped to a permission entry in the permission table. Because of a one-to-one mapping relationship, a corresponding permission entry can be read according to a permission entry index number.

For each new file generated in the computer, the entry identifier is generated by default in metadata of the file, where the entry identifier points to an index entry corresponding to the file. For example, an entry identifier a exists in metadata of a file A, an index entry B in a permission entry records an entry identifier b, and when the entry identifier a is the same as the entry identifier b, the index entry corresponding to the file A is the index entry B. Evidently, “the entry identifier points to an index entry corresponding to the file” means that the entry identifier a points to the index entry B that has the same entry identifier as the file A.

That is, the metadata of the file includes the entry identifier, and each permission entry of the permission table also includes the entry identifier. Therefore, the permission entry that has the same entry identifier can be found according to the entry identifier in the metadata of the file, thereby forming a mapping relationship between the entry identifier in the metadata and the permission entry. Because the metadata uniquely corresponds to the file, the permission entry is the permission entry of the file represented by the metadata. The mapping relationship may be denoted by file-metadata of the file-entry identifier in the metadata of the file-entry identifier in the index entry-index entry. A one-to-one mapping relationship exists between any two of the five elements.

It should be especially noted that in this embodiment and other embodiments, the metadata of the file includes an entry index, and the entry index points to an index entry in the index table, and the index entry pointed to records the permission entry index number of the file. The entry index may point to the index entry in multiple manners, for example, may point to the index entry that records the same entry index, or may point to the entry using an address, a pointer, and so on.

In addition, when the same index entry includes more than one permission entry index number, different permission entry index numbers are mapped to different permission entries in the permission table.

In addition, in the permission table, each permission entry records a permission entry index number, access control permission for a file corresponding to the permission entry, and an identifier of a user that has the access control permission, and the different permission entries to which the different permission entry index numbers in the same index entry are mapped to record the access control permission for the same file.

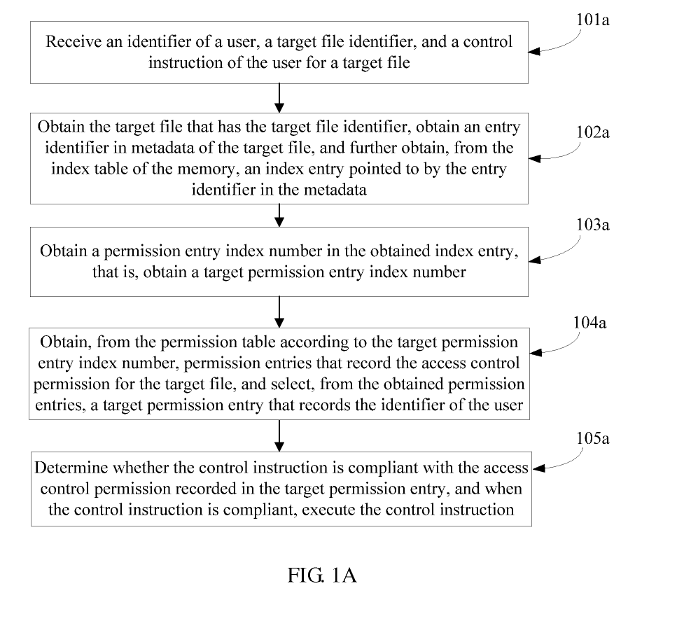

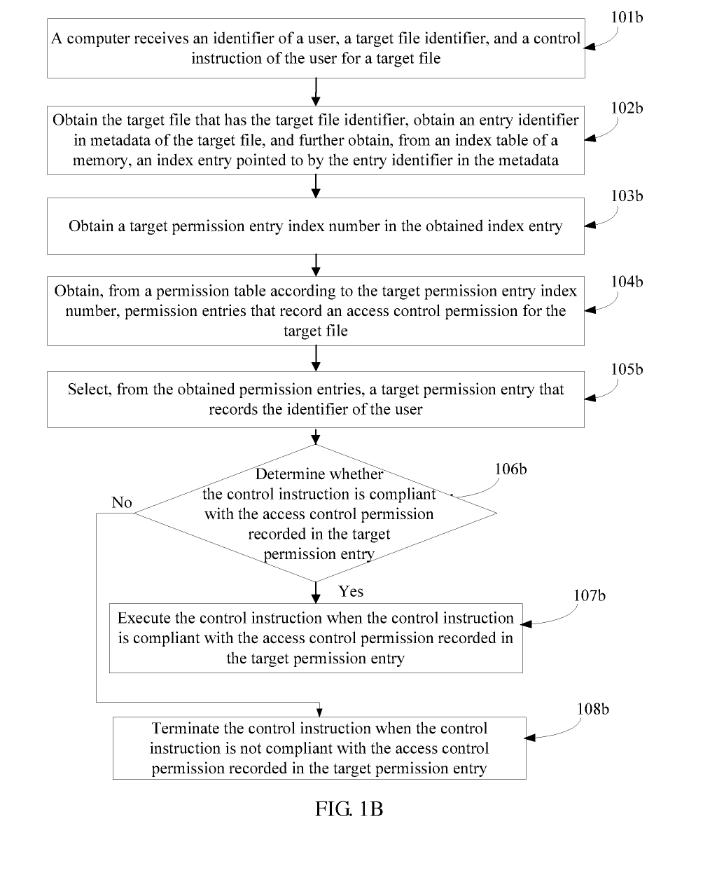

The method is shown in FIG. 1A, and the method includes the following steps:

101a. Receive an identifier of a user, a target file identifier, and a control instruction of the user for a target file.

The access control permission management method provided in this embodiment of the present invention is applicable to a computer device. In one case, a memory (such as a hard disk) may be integrated in the computer device; and in another case, the computer device is interconnected with an independent memory. In any one of the foregoing cases, an index table and a permission table need to be constructed in the memory in advance before the entire computer system is put into operation.

When the computer receives the control instruction of the user for the target file, access control permission for the target file can be found by accessing the index table and the permission table, thereby determining whether it is allowed to execute the user's control instruction.

Further, a description is given with reference to FIG. 10. 1001 is a target file. When the file 1001 is created in the computer, metadata 1002 is generated at the same time. The metadata may include information such as file creation time and a physical storage location of the file. In this embodiment of the present invention, data a1 is generated in the metadata 1002 by default. As an entry identifier, a1 points to an index entry 1004.

In addition, in FIG. 10, 1003 is an index table, and 1005 is a permission table. Each file in the computer corresponds to a unique index entry in the index table, and each index entry includes an entry identifier and a permission entry index number. With reference to the index entry 1004 in FIG. 10, in the index entry, the data a1 generated in the metadata 1002 is used as an entry identifier. Because a1 is recorded in the metadata 1002 of the file and is an entry identifier, a mapping relationship between the file 1001 and the index entry 1004 can be established. b11 and b12 are permission entry index numbers. Because b11 and b12 are located in the same index entry 1004 and the entry identifier of the index entry 1004 is provided by the metadata 1002, b11 and b12 point to the same metadata 1002 and point to the same file 1001. In addition, in the permission table 1005, the index number of a permission entry 1006 is b11, the index number of a permission entry 1007 is b12, and read-write permission is specified in the permission entry.

As learned from the foregoing description, if the target file is determined, the read-write permission for the target file can be found level by level using the index table and the permission table. For example, a user A has read-only permission for the target file 1001, and a user B has read-write permission for the target file 1001.

102a. Obtain the target file that has the target file identifier, obtain an entry identifier in metadata of the target file, and further obtain, from the index table of the memory, an index entry pointed to by the entry identifier in the metadata.

In step 102a, the target file can be determined first according to the target file identifier, the entry identifier in the metadata of the target file is obtained, and then the index entry pointed to by the entry identifier is obtained from the index table.

With reference to step 101a in this embodiment of the present invention, when the computer receives the control instruction of the user for the target file, the computer receives two pieces of information concurrently: the identifier of the user and the target file identifier. First, the computer determines the target file according to the target file identifier, obtains the metadata of the target file, obtains the entry identifier in the metadata, and then can obtain, from the index table, the index entry pointed to by the entry identifier.

The memory may exist on an NAS device or a file sharing server.

103a. Obtain a permission entry index number in the obtained index entry, that is, obtain a target permission entry index number.

104a. Obtain, from the permission table according to the target permission entry index number, permission entries that record the access control permission for the target file, and select, from the obtained permission entries, a target permission entry that records the identifier of the user.

Step 104 is explained as follows: First, permission entries are obtained from the permission table according to the target permission entry index number, where the permission entries record the access control permission for the target file. Then, from the obtained permission entries, the permission entry that records the identifier of the user in step 101a is selected as the target permission entry.

As shown in FIG. 10, the permission entries 1006 and 1007 in the permission table 1005 are found according to b11 and b12 in the index entry 1004. The user “A” recorded in the permission entry 1006 has “read-only” permission, and the user “B” recorded in the permission entry 1007 has “read-write” permission. According to the identifier of the user received in step 101a, the target permission entry that matches the identifier of the user received in 101a can be selected.

In an actual scenario, each user may have different read-write permission for different files. Therefore, using the index table 1003, the permission entries of different users for the same file can be selected. As shown in FIG. 10, the index table 1003 further includes an index entry 1009, whose entry identifier is a4, where a4 is generated in metadata 1011 in another file 1010. According to the permission entry index number b31, it can be learned that the read-write permission of the user “A” for the file 1010 is recorded in a permission entry 1008. When the user “A” expects to modify the permission for the file 1001, the computer finds the permission entry 1006 instead of 1008 by selection in the index table 1003.

105a. Determine whether the control instruction is compliant with the access control permission recorded in the target permission entry, and when the control instruction is compliant, execute the control instruction.

For example, if the control instruction is a read instruction, when the access control permission includes read permission, it is allowed to execute the control instruction; otherwise, it is not allowed to execute the control instruction. The access control permission that includes read permission includes read-only permission, and read-write permission.

From the perspective of specific control actions, the control instructions include but are not limited to a read instruction, a write instruction, and an execute instruction.

The access control permission that can be stored in the permission entry is write-only permission, read-write permission, and other permission that is set by an administrator. When the access control permission stored in the permission entry is read-only permission, an operating system of the computer can perform a read operation for the target file if the control instruction meets requirements.

Example 1 is an example for describing steps 101a to 105a. As shown in FIG. 10, 1001 is a target file, and 1002 is metadata of the target file. When 1001 is created, the metadata 1002 is also created, and a1 is generated in 1002 by default, where a1 is recorded as an entry identifier into the index entry 1004.

When the computer receives a control instruction (and receives a user identifier B of a user who sends the control instruction, and a target file identifier), the computer determines metadata of the target file first according to the target file identifier, and obtains the entry identifier a1 from the metadata. Then the computer matches a1 with the entry identifier of each index entry in the index table 1003, finds the index entry 1004 whose entry identifier is al, and obtains the permission entry index numbers b11 and b12 in the index entry 1004. The permission entry 1006 and the permission entry 1007 corresponding to b11 and b12 are determined in the permission table 1005 according to the permission entry index numbers b11 and b12. Because the user identifier is B, it is determined that the permission entry 1006 that does not include the user identifier B is not the permission entry corresponding to the target file 1001, and that the permission entry 1007 that includes the user identifier B is the permission entry corresponding to the target file 1001. The access control permission obtained in the permission entry 1007 is read-write permission, and therefore, the control instruction can execute a read-write operation for the target file 1001. That is, the user B has read-write permission for the target file, and any read request or write request that carries the user identifier B can be executed.

In a practical application, the target file in the memory may be accessed by control instructions sent by different operating systems. The same user has different user identifiers in different operating systems, and therefore, different operating systems need to have their corresponding index table and permission table in order to control the access control permission for the target file. When the system receives a control instruction, the system first obtains a type of the operating system that sends the control instruction, and then finds the index table and the permission table corresponding to the operating system, and finally, obtains the access control permission corresponding to the control instruction. The operating systems in this embodiment of the present invention include but are not limited to a Windows operating system, a Linux operating system, and a UNIX operating system.

This embodiment of the present invention provides an access control permission management method. A computer first receives an identifier of a user, a target file identifier, and a control instruction of the user for a target file, obtains the target file that has the target file identifier, obtains an entry identifier in metadata of the target file, and further obtains, from an index table, an index entry pointed to by the entry identifier; and then obtains a target permission entry index number in the obtained index entry, and obtains, from a permission table according to the target permission entry index number, permission entries that record access control permission for the target file, and selects, from the obtained permission entries, a target permission entry that records the identifier of the user; and when determining that the control instruction is compliant with the access control permission recorded in the target permission entry, executes the control instruction. Based on the foregoing solution, the index table and the permission table are used to manage access control permission information, which reduces complexity of managing the access control permission information in the memory and increases the system running speed if massive access control permission information exists in the memory.

### Embodiment 2

An embodiment of the present invention provides a method for a storage device accessing a file. The following steps of the method are executed by a computer. As shown in FIG. 1B, the method includes the following steps:

101b. A computer receives an identifier of a user, a target file identifier, and a control instruction of the user for a target file.

102b. Obtain the target file that has the target file identifier, obtain an entry identifier in metadata of the target file, and further obtain, from an index table of a memory, an index entry pointed to by the entry identifier in the metadata.

103b. Obtain a target permission entry index number in the obtained index entry.

104b. Obtain, from a permission table according to the target permission entry index number, permission entries that record access control permission for the target file.

105b. Select, from the obtained permission entries, a target permission entry that records the identifier of the user.

106b. Determine whether the control instruction is compliant with the access control permission recorded in the target permission entry.

From the perspective of specific control actions, the control instructions include, but are not limited to, a read instruction, a write instruction, and an execute instruction. In this case, whether the control instruction is compliant with the access control permission recorded in the target permission entry is determined, and if the control instruction is compliant, step 107b is performed, otherwise, step 108b is performed.

107b. Execute the control instruction when the control instruction is compliant with the access control permission recorded in the target permission entry.

For example, if the control instruction sent by a user A for a file A is a read instruction and access control permission of the user A for the file A recorded in the target permission entry is read permission, because the access control permission required by the control instruction is consistent with the access control permission recorded in the target permission entry, the user A is allowed to read the file A; and in another case, if the control instruction sent by the user A for the file A is a read instruction but the access control permission of the user A for the file A recorded in the target permission entry is read-write permission, because the read-write permission includes the read permission, the user A is also allowed to read the file A.

108b. Terminate the control instruction when the control instruction is not compliant with the access control permission recorded in the target permission entry. Either step 107b or step 108b is performed, and the two steps are not performed concurrently.

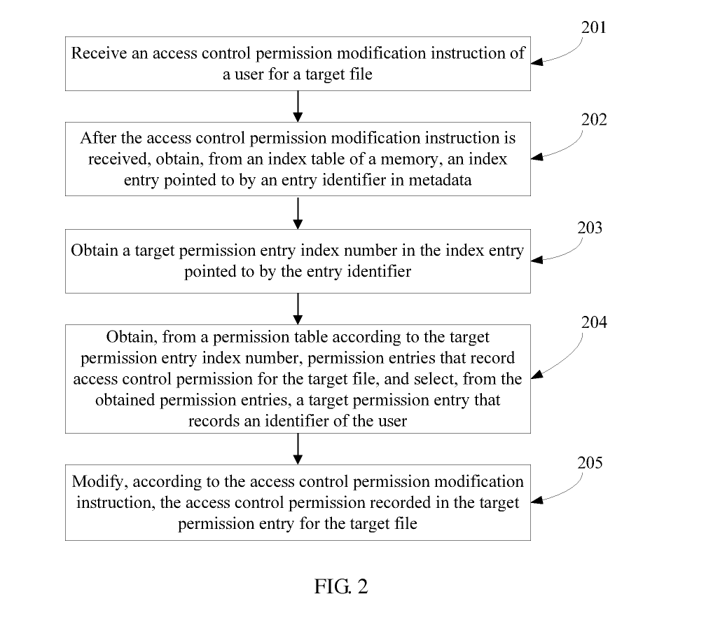

Further, as shown in FIG. 2, in this embodiment of the present invention, after the computer receives the identifier of the user, the target file identifier, and the control instruction of the user for the target file, the method further includes the following steps:

201. Receive an access control permission modification instruction of the user for the target file.

The access control permission modification instruction is an instruction for modifying the access control permission for the target file.

202. After the access control permission modification instruction is received, obtain, from the index table of the memory, an index entry pointed to by the entry identifier in the metadata.

The computer can access the target file according to the target file identifier, and then find the metadata of the target file, and obtain, according to the entry identifier stored in the metadata, the index entry pointed to by the entry identifier in the index table.

203. Obtain the target permission entry index number in the index entry pointed to by the entry identifier.

204. Obtain, from the permission table according to the target permission entry index number, the permission entries that record the access control permission for the target file, and select, from the obtained permission entries, the target permission entry that records the identifier of the user.

The following describes the foregoing steps briefly. Reference is made to FIG. 10. It is assumed that the access control permission modification instruction is targeted at a target file 1001, and targeted at the user “A”. When an index entry 1004 is found according to an entry identifier a1, it is learned that the index entry records a permission entry index number b11 and an index number b12. Therefore, it is learned that b11 and b12 in a permission table 1005 correspond to a permission entry 1006 and a permission entry 1007. Because it is learned that the identifier of the user is “A”, the computer can determine that the permission entry 1006 is the permission entry to be modified according to the access control permission modification instruction.

205. Modify, according to the access control permission modification instruction, the access control permission recorded in the target permission entry for the target file.

The modification in step 205 may be modifying read-only access control permission to write-only access control permission, or deleting the access control permission of the user for the target file, or adding the access control permission of the user for the target file. The access control permission includes read-only permission, write-only permission, read-write permission, and execute permission, and may also be other permission that is set by an administrator, which is not further described herein.

A manner of modifying the access control permission may be directly modifying the access control permission in the target permission entry, or modifying the access control permission in the following way:

After the target permission entry is determined, the target permission entry is deleted; and then a new permission entry is added, where the access control permission of the new permission entry is set to be the access control permission indicated by the access control permission modification instruction, thereby modifying the original access control permission to new access control permission; and finally, an identifier of the user that has the new access control permission and a new permission entry index number are stored into the new permission entry. In the index table, the permission entry index number in the index entry corresponding to the target file is modified to the new permission entry index number. For example, as shown in FIG. 11, the access control permission modification instruction instructs modify access control permission, for a target file 201a, of the user whose identifier is A from read-only permission to read-write permission. First, an index entry 204a in an index table 203a is found according to an entry identifier a1 recorded in metadata 202a; a permission entry that records b11 and b12 is found in a permission table 205a; then a permission entry 206a corresponding to the user A is deleted, a new permission entry 207a is added in the permission table 205a, the access control permission in the permission entry is set to read-write permission, the identifier of the user is set to A, and the permission entry index number is set to b22; and finally, in the index table 203a, the permission entry index number in the index entry 204a is modified from the original b11 to b22.

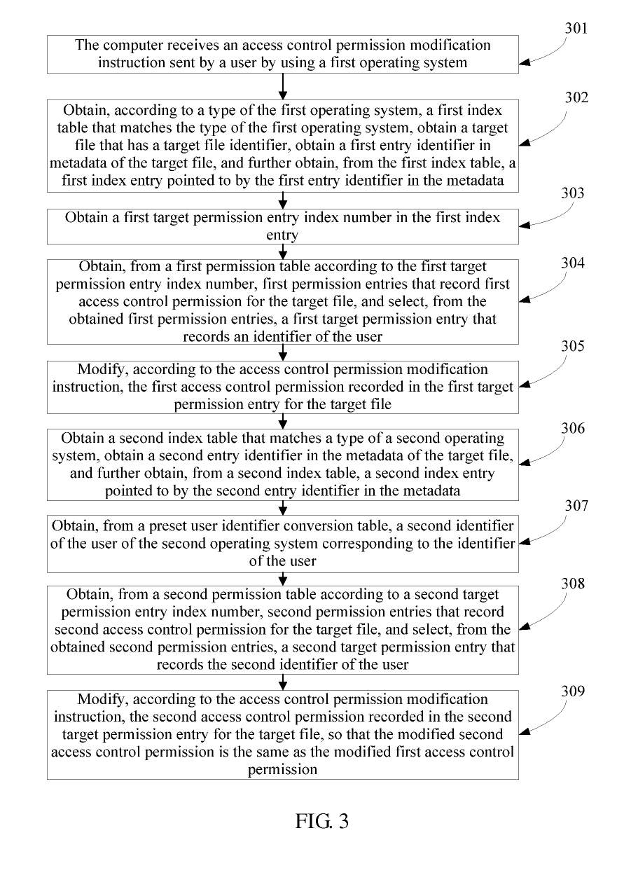

In an application scenario, the memory may exist on a NAS device or a file sharing server, and the user may use computers with different operating systems to access files in the memory. In this case, after the user modifies the access control permission for the target file in the memory using a first operating system, the modification needs to be synchronized to other operating systems except the first operating system. Otherwise, the result of the user modifying the access control permission for the target file using the first operating system does not take effect in other operating systems. On this basis, this embodiment of the present invention further provides a method for a storage device accessing a file. As shown in FIG. 3, the method includes the following steps:

301. The computer receives an access control permission modification instruction sent by the user using the first operating system.

302. Obtain, according to a type of the first operating system, a first index table that matches the type of the first operating system, obtain the target file that has the target file identifier, obtain a first entry identifier in the metadata of the target file, and further obtain, from the first index table, a first index entry pointed to by the first entry identifier in the metadata.

The memory exists on an NAS device or a file sharing server, and the user sends the access control permission modification instruction using the first operating system. Different operating systems have different access control permission formats, and therefore, each operating system corresponds to an index table and a permission table. Herein the first operating system is used as an example. The index table and the permission table corresponding to the first operating system are a first index table and a first permission table respectively.

The first index table is composed of multiple first index entries. Each first index entry records a first entry identifier and at least one first permission entry index number. The first entry identifier is generated by default in metadata of each newly generated file, so that the first entry identifier points to the first index entry corresponding to the file in the first operating system, where different first permission entry index numbers in the same first index entry are mapped to different first permission entries in the first permission table.

In addition, each first permission entry records a first permission entry index number, first access control permission for the file corresponding to the first permission entry, and an identifier of a user that has the first access control permission, and the different first permission entries to which the different first permission entry index numbers in the same first index entry are mapped to record the first access control permission for the same file.

Evidently, the composition structure of the first index table is consistent with that of the index table in Embodiment 1 and Embodiment 2 of the present invention, and the composition structure of the first permission table is consistent with that of the permission table in Embodiment 1 and Embodiment 2 of the present invention.

303. Obtain a first target permission entry index number in the first index entry.

A first permission entry pointed to by the first target permission entry index number records the first access control permission for the target file.

304. Obtain, from the first permission table according to the first target permission entry index number, first permission entries that record the first access control permission for the target file, and select, from the obtained first permission entries, a first target permission entry that records the identifier of the user.

The first permission table records the first permission entry index number. The following describes steps 302 to 304 briefly. Reference is made to FIG. 10. It is assumed that an index table 1003 in FIG. 10 is a first index table that matches the first operating system, and that the permission table 1005 is a first permission table that matches the first operating system. When the first index entry obtained is the index entry 1004, it is learned that the index entry records the first target permission entry index number b11 and index number b12, and it is learned that the first permission entries corresponding to the index number b11 and the index number b12 in the first permission table 1005 are the permission entry 1006 and the permission entry 1007 respectively. Because it is learned that the identifier of the user is “A”, the computer can determine that the first permission entry 1006 is the first target permission entry. According to the foregoing description, the computer can precisely find the first target permission entry according to the first target permission entry index number and the identifier of the user.

305. Modify, according to the access control permission modification instruction, the first access control permission recorded in the first target permission entry for the target file.

Steps 302 to 305 complete the modification of the first access control permission corresponding to the first operating system.

306. Obtain a second index table that matches a type of a second operating system, obtain a second entry identifier in the metadata of the target file, and further obtain, from the second index table, a second index entry pointed to by the second entry identifier in the metadata.

An index table and a permission table corresponding to the second operating system are a second index table and a second permission table respectively.

The second index table is composed of multiple second index entries. Each second index entry records a second entry identifier and at least one second permission entry index number. The second entry identifier is generated by default in metadata of each newly generated file, so that the second entry identifier points to the second index entry corresponding to the file in the second operating system, where different second permission entry index numbers in the same second index entry are mapped to different second permission entries in the second permission table.

In addition, each second permission entry records a second permission entry index number, second access control permission for the file corresponding to the second permission entry, and a second identifier of a user that has the second access control permission, and the different second permission entries to which the different second permission entry index numbers in the same second index entry are mapped to record the second access control permission for the same file.

Entry identifiers for different operating systems may be generated in the metadata of the target file, and the index tables corresponding to different operating systems can be determined according to the entry identifiers. For example, when the target file is created, the entry identifier for the first operating system and the entry identifier for the second operating system are generated in the metadata of the target file by default. When the user modifies the access control permission for the target file in the first operating system, the corresponding first index entry is found according to the entry identifier for the first operating system, and then the first target permission entry is found and the first access control permission can be modified. After the first access control permission is modified, the second access control permission for the second operating system also needs to be modified, so as to ensure consistent access control permission for the target file when the same user accesses the same target file on different operating systems.

307. Obtain, from a preset user identifier conversion table, the second identifier of the user of the second operating system corresponding to the identifier of the user.

The user identifier conversion table records different identifiers of the same user on different types of operating systems.

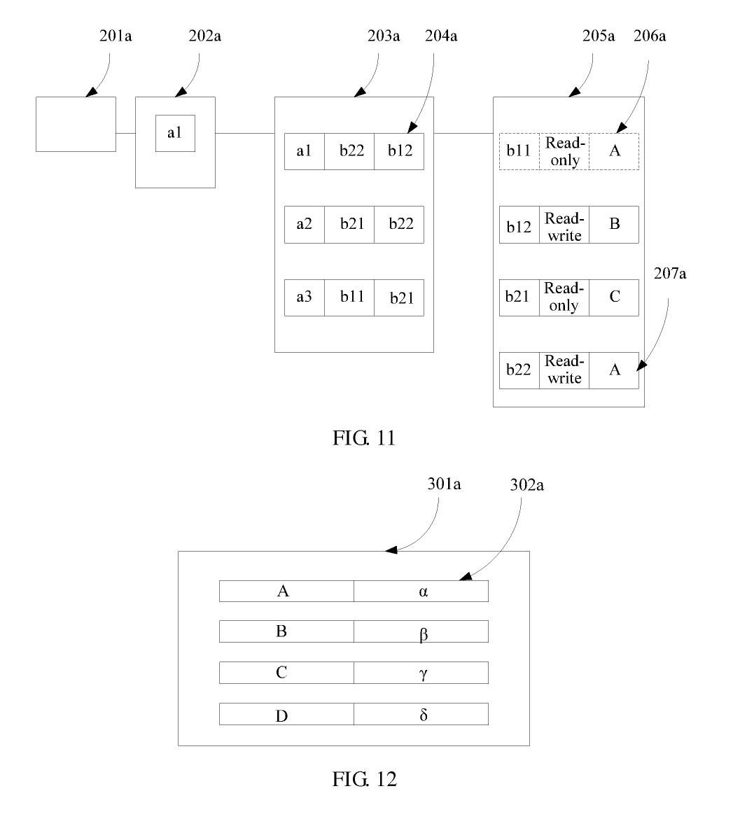

As shown in FIG. 12, a user identifier conversion table 301a is composed of several entries 302a. The entries 302a record the identifier of the user of the operating system and the second identifier of the user of the second operating system corresponding to the identifier of the user. As shown in the figure, in the entry 302a, the identifier of the user of the first operating system is A, and the second identifier of the user of the corresponding second operating system is α.

308. Obtain, from the second permission table according to the second target permission entry index number, second permission entries that record the second access control permission for the target file, and select, from the obtained second permission entries, a second target permission entry that records the second identifier of the user.

309. Modify, according to the access control permission modification instruction, the second access control permission recorded in the second target permission entry for the target file, so that the modified second access control permission is the same as the modified first access control permission.

Different operating systems correspond to different index tables and permission tables. The first operating system corresponds to the first index table and the first permission table, and the second operating system corresponds to the second index table and the second permission table. After receiving the control instruction of the user for the target file, the computer first obtains the type of the operating system of the user, and then finds, according to the type of the operating system, the access control permission stored in the permission table. When the access control permission is modified, it is necessary to modify the first permission table corresponding to the first operating system and the second permission table corresponding to the second operating system.

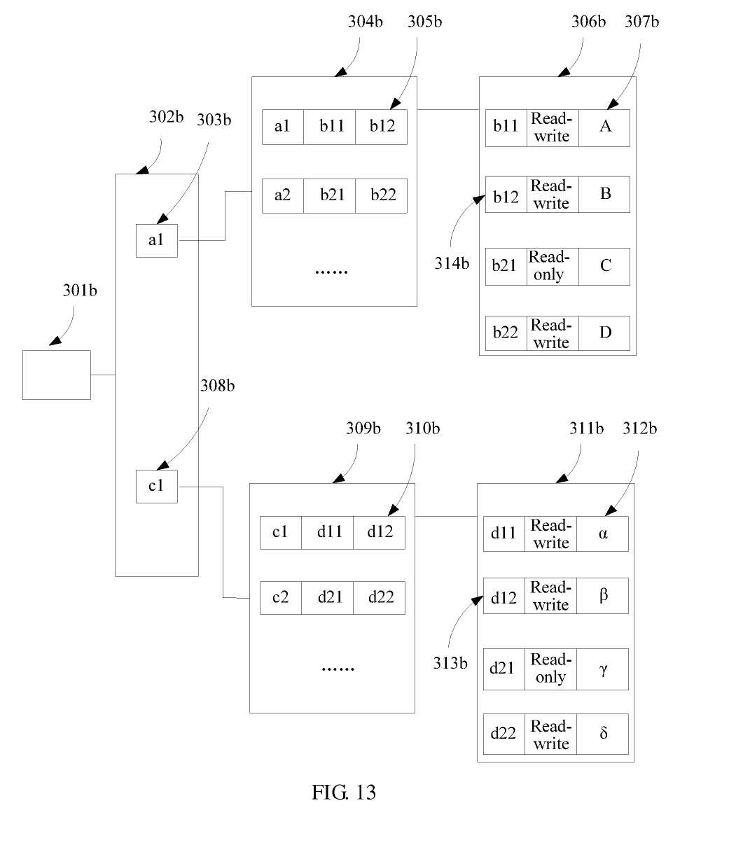

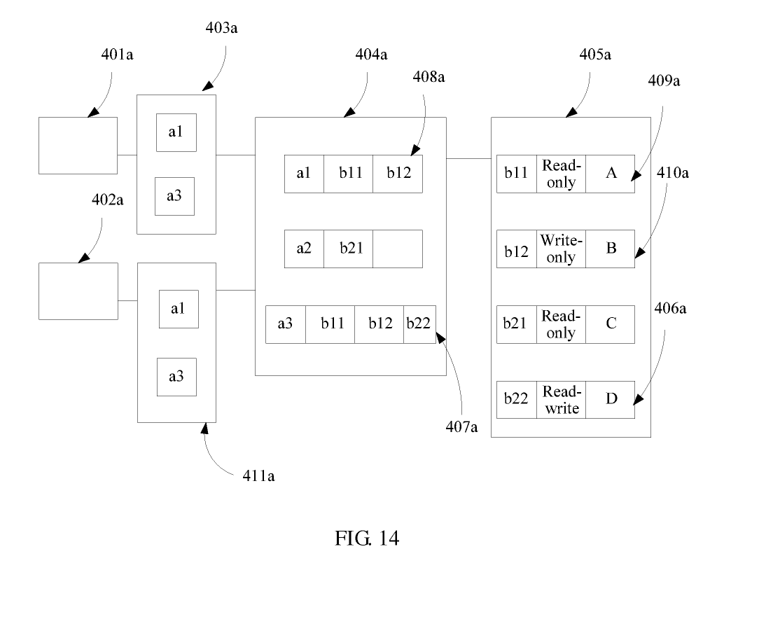

The following gives a description using an example. As shown in FIG. 13, in metadata 302b of a file 301b, two values are generated by default: a first entry identifier a1 and a second entry identifier c1. The entry identifier a1 points to a first index entry 305b in a first index table 304b. As a second entry identifier, the entry identifier c1 points to a second index entry 310b in a second index table 309b. The computer receives the access control permission modification instruction sent by the user on the first operating system, where the instruction instructs to modify the access control permission for the target file 301b from read-only permission to read-write permission. Meanwhile, the computer receives the user identifier A of the user in the first operating system. First, the computer obtains the first index table 304b that matches the operating system type of the first operating system, obtains, according to the first entry identifier 303b generated in the metadata 302b of the target file, the 304b and the first index entry 305b corresponding to the target file, finds the first target permission entry index number b11 and the first target permission entry index number b12 in the first index entry 305b, and then determines, in two permission entries 307b and 314b in a first permission table 306b, the first target permission entry 307b that records the user identifier A, and modifies the read-only permission stored in the first target permission entry 307b to read-write permission.

After completion of the modification, the system obtains the second index entry 310b in the second index table 309b according to a second entry identifier 308b in the metadata 302b of the target file. The second index entry 310b carries a second target permission entry index number d11 and a second target permission entry index number d12, which correspond to a second permission entry 312b and a second permission entry 313b respectively; and after the user identifier a in the second operating system corresponding to the user identifier A in the first operating system is found in a user identifier conversion table, the second permission entry 312b is determined as the second target permission entry in the second permission entry 312b and the second permission entry 313b, and read-only permission stored in the second permission entry 312b is modified to read-write permission. In this way, the access control permission in the first target permission entry 307b is the same as that in the second permission entry 312b, and it is ensured that the same user has the same access control permission for the file 301b in the first operating system and the second operating system.

In a practical application, the operating system may be a Windows operating system, a Linux operating system, a UNIX operating system, or other operating systems. Each operating system corresponds to an index table and a permission table. The same user has a corresponding identifier of the user in each operating system, and all identifiers are recorded in the user identifier conversion table. When the access control permission modification instruction instructs to modify the access control permission for the target file, it is necessary to modify each permission table in each system, so as to ensure that the same user has the same permission for the same target file after the user logs in to different operating systems. After the permission table in an operating system is modified, the permission tables in other operating systems can be modified by traversing the metadata.

A case of two different operating systems is described above using only the first operating system and the second operating system as an example. In a practical application, this embodiment of the present invention may be applied to more than three different operating systems.

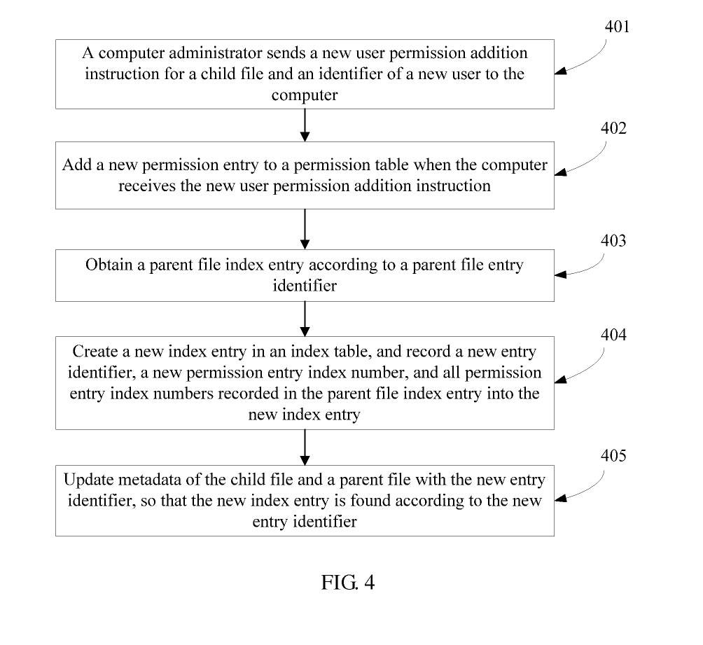

Generally, when a new file is added in the computer, if the new file is located in a directory of an existing file, the existing file is a parent file of the new file, and the new file is a child file of the existing file. The child file can automatically inherit the access control permission for its parent file. In this embodiment of the present invention, when a child file is created in the directory of a parent file, the child file inherits a parent file entry identifier of its parent file. The parent file entry identifier points to a parent file index entry. In this way, the child file and the parent file use the same parent file entry identifier to point to the parent file index entry, so that the child file can inherit the access control permission for the parent file. In this scenario, to manage the access control permission for the child file, this embodiment of the present invention further provides a method for a storage device accessing a file. As shown in FIG. 4, the method includes the following steps:

401. A computer administrator sends a new user permission addition instruction for the child file and an identifier of a new user to the computer.

When expecting to add access control permission of a new user for the child file, the administrator sends the new user permission addition instruction. The new user permission addition instruction includes the access control permission of the new user for the child file.

402. Add a new permission entry to the permission table when the computer receives the new user permission addition instruction.

The new permission entry includes a new permission entry index number, the access control permission of the new user for the child file, and the identifier of the new user.

403. Obtain the parent file index entry according to the parent file entry identifier.

404. Create a new index entry in the index table, and record a new entry identifier, the new permission entry index number, and all permission entry index numbers recorded in the parent file index entry into the new index entry.

405. Update metadata of the child file and the parent file with the new entry identifier, so that the new index entry is found according to the new entry identifier.

The following describes steps 401 to 405 using an example. As shown in FIG. 14, 402a is a child file created in the directory of a file 401a. When 402a is created, access control permission for 401a is inherited. When the parent file 401a of 402a is created, a value a1 is generated in its metadata 403a. As an entry identifier, a1 points to an index entry 408a in an index table 404a. When the child file 402a is created, a1 in 403a is stored into metadata 411a, and therefore, the index entry corresponding to the child file 402a is also the index entry 408a, and the child file 402a inherits the access control permission for the parent file 401a. The permission entries 409a and 410a can be obtained in the permission table 405a according to b11 and b12 recorded in the index entry 408a.

It is assumed that the new user permission addition instruction sent by the administrator is targeted at the child file 402a, the identifier of the new user is “D”, and the access control permission indicated by the new user permission addition instruction is “read-write” permission. Therefore, the computer adds a new permission entry 406a to the permission table 405a, and records the identifier of the new user “D”, the access control permission “read-write”, and a new permission entry index number b22 into the permission entry 406a. The new permission entry index number b22 is allocated by the computer at the time of creating 406a, and the new permission entry index number is not the same as any existing permission entry index number.

After “D”, “read-write” and “b22” are recorded into 406a, a new index entry 407a is created in the index table 404a, a new entry identifier a3 and the new permission entry index number b22 are recorded into the new index entry 407a, the index entry 408a is found according to the entry index a1 of the parent file 401a, and b11 and b12 in the index entry 408a are copied into the new index entry 407a. In this way, b11, b12, and b22 are all recorded in the new index entry 407a. It should be noted that the new entry identifier a3 is generated by the computer at the time of creating 407a, and that the value of a3 is not the same as the value of any other existing entry identifier.

Finally, the new entry identifier a3 is updated in the metadata of the child file and the parent file and replaces the original a1. In this way, although no inheritance relationship exists between the child file 402a and the parent file 401a any longer (the user D has no permission for the parent file 401a but has read-write permission for the child file 402a), the access control permission of different users for the parent file 401a and the child file 402a can be found according to the index entry 407a.

This embodiment of the present invention provides an access control permission management method. When the control instruction for the target file is received from the user, the index entry pointed to by the entry identifier is obtained from the index table first, and then the target permission entry that records the access control permission for the target file is obtained from the permission table, and finally, whether execution of the control instruction is allowed is determined according to the access control permission in the target permission entry. Based on the foregoing solution, the index table and the permission table are used to manage access control permission information, which reduces complexity of managing the access control permission information in the memory and increases the system running speed if massive access control permission information exists in the memory.

In addition, when an access control permission modification instruction is received, the index entry pointed to by the entry identifier is obtained from the index table, and then, in the permission table, the access control permission in the target permission entry is found and modified. The access control permission is modified using the index table and the permission table, which reduces operation complexity of modifying the access control permission information in the memory. In addition, in a scenario where the user can use different operating systems to access files in the memory, when the permission of the permission entry of the target file is modified, all permission tables of different systems are modified, so as to ensure consistency of the access control permission for the target file when the same user accesses the same target file on different operating systems.

Further, when access control permission of a new user for a child file is added, a new permission entry is added in the permission table, a new index entry is added in the index table, and the entry identifier is changed so that the new index entry points to both the child file and the parent file. In this modification manner, if no inheritance relationship exists between the child file and the parent file any longer, the access control permission of their respective users can still be found according to the new index entry, which reduces the operation complexity and increases the system running speed in the process of adding user management permission information.

### Embodiment 3

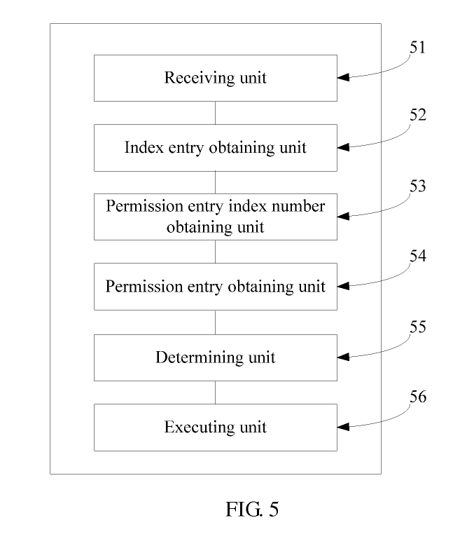

An embodiment of the present invention provides an access control permission management apparatus. As shown in FIG. 5, the apparatus includes a receiving unit 51 configured to receive an identifier of a user, a target file identifier, and a control instruction of the user for a target file; an index entry obtaining unit 52 configured to obtain the target file that has the target file identifier, obtain an entry identifier in metadata of the target file, and further obtain, from the index table of a memory, an index entry pointed to by the entry identifier in the metadata; a permission entry index number obtaining unit 53 configured to obtain a target permission entry index number in the index entry obtained by the index entry obtaining unit 52, where a permission entry pointed to by the target permission entry index number records access control permission for the target file; a permission entry obtaining unit 54 configured to obtain, from the permission table according to the target permission entry index number obtained by the permission entry index number obtaining unit 53, permission entries that record the access control permission for the target file, and select, from the obtained permission entries, a target permission entry that records the identifier of the user; a determining unit 55 configured to determine whether the control instruction is compliant with the access control permission recorded in the target permission entry obtained by the permission entry obtaining unit 54; and an executing unit 56 configured to execute the control instruction when the determining unit 55 determines that the control instruction is compliant with the access control permission recorded in the target permission entry.

The memory stores an index table and a permission table. The index table is composed of multiple index entries, and each index entry records an entry identifier and at least one permission entry index number. The entry identifier is generated by default in the metadata of each newly generated file, so that the entry identifier points to the index entry corresponding to the file, where different permission entry index numbers in the same index entry are mapped to different permission entries in the permission table. In addition, each permission entry records a permission entry index number, access control permission for the file corresponding to the permission entry, and an identifier of a user that has the access control permission, and the different permission entries to which the different permission entry index numbers in the same index entry are mapped to record the access control permission for the same file.

For detailed descriptions about the index table and the permission table, reference may be made to Embodiment 1 and Embodiment 2 of the present invention, and the details are not described herein again.

From the perspective of specific control actions, the control instructions include, but are not limited to, a read instruction, a write instruction, and an execute instruction.

Further, the executing unit 56 is further configured to terminate the control instruction when the control instruction is not compliant with the access control permission recorded in the target permission entry.

Further, the receiving unit 51 is configured to receive an access control permission modification instruction of the user for the target file after receiving the identifier of the user, the target file identifier, and the control instruction of the user for the target file.

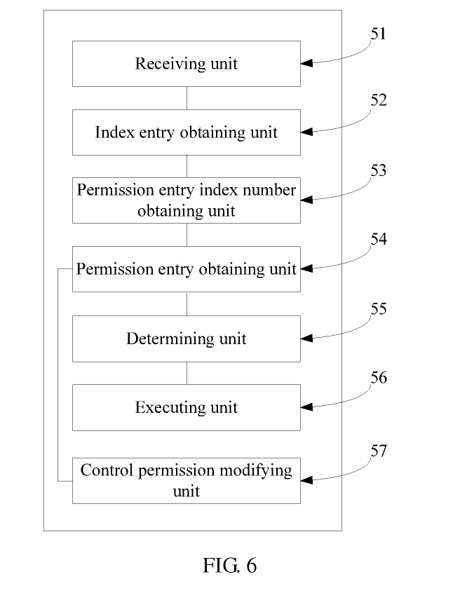

As shown in FIG. 6, the apparatus further includes a control permission modifying unit 57 configured to modify, according to the access control permission modification instruction, the access control permission recorded in the target permission entry for the target file.

The control permission modifying unit 57 is configured to delete the access control permission of the user for the target file; or add the access control permission of the user for the target file; where, when existing access control permission needs to be changed, the control permission modifying unit 57 first performs an action of deleting the access control permission, and then adds new access control permission in the location of the original access control permission, thereby changing the existing access control permission.

The access control permission includes read-only permission, write-only permission, read-write permission, and execute permission.

In an application scenario, the memory may exist on a NAS device or a file sharing server, and the user may use computers with different operating systems to access files in the memory. In this case, after the user modifies the access control permission for the target file in the memory using a first operating system, the modification needs to be synchronized to other operating systems except the first operating system. Otherwise, the result of the user modifying the access control permission for the target file using the first operating system does not take effect in other operating systems. On this basis, the index entry obtaining unit 52 is configured to obtain, according to a type of the first operating system, a first index table that matches the type of the first operating system, obtain the target file that has the target file identifier, obtain a first entry identifier in the metadata of the target file, and further obtain, from the first index table, a first index entry pointed to by the first entry identifier in the metadata.

The permission entry index number obtaining unit 53 is configured to obtain a first target permission entry index number in the first index entry, where a first permission entry pointed to by the first target permission entry index number records first access control permission for the target file.

The permission entry obtaining unit 54 is configured to obtain, from the first permission table according to the first target permission entry index number, first permission entries that record the first access control permission for the target file, and select, from the obtained first permission entries, a first target permission entry that records the identifier of the user.

The control permission modifying unit 57 is configured to modify, according to the access control permission modification instruction, the first access control permission recorded in the first target permission entry for the target file.

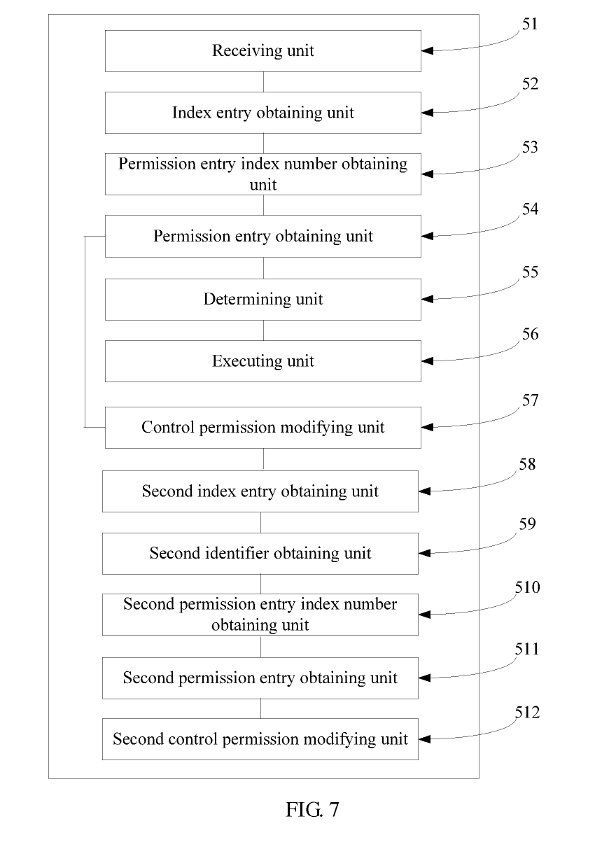

Further, on the basis of FIG. 6, as shown in FIG. 7, the apparatus includes a second index entry obtaining unit 58 configured to after the control permission modifying unit 57 modifies, according to the access control permission modification instruction, the first access control permission recorded in the first target permission entry for the target file, obtain a second index table that matches a type of a second operating system, obtain a second entry identifier in the metadata of the target file, and further obtain, from the second index table, a second index entry pointed to by the second entry identifier in the metadata; a second identifier obtaining unit 59 configured to obtain, from a preset user identifier conversion table, the second identifier of the user of the second operating system corresponding to the identifier of the user, where the user identifier conversion table records different identifiers of the same user on different types of operating systems; a second permission entry index number obtaining unit 510 configured to obtain a second target permission entry index number in the second index entry, where a second permission entry pointed to by the second target permission entry index number records second access control permission for the target file; a second permission entry obtaining unit 511 configured to obtain, from the second permission table according to the second target permission entry index number, second permission entries that record the second access control permission for the target file, and select, from the obtained second permission entries, a second target permission entry that records the second identifier of the user; and a second control permission modifying unit 512 configured to modify, according to the access control permission modification instruction, the second access control permission recorded in the second target permission entry for the target file, so that the modified second access control permission is the same as the modified first access control permission.

For descriptions about the composition structure of the first index table, the first permission table, the second index table, and the second permission table, reference may be made to Embodiment 2 of the present invention, and the details are not described herein again.

Further, generally, when a new file is added in the computer, if the new file is located in a directory of an existing file, the existing file is a parent file of the new file, and the new file is a child file of the existing file. The child file can inherit the access control permission for its parent file automatically. In the embodiment of the present invention, when a child file is created in the directory of a parent file, the child file inherits a parent file entry identifier of its parent file. The parent file entry identifier points to a parent file index entry. In this way, the child file and the parent file use the same parent file entry identifier to point to the parent file index entry, so that the child file can inherit the access control permission for the parent file.

In this scenario, to manage the access control permission for the child file, the receiving unit 51 is further configured to receive a new user permission addition instruction and an identifier of a new user sent by a computer administrator for the child file, where the new user permission addition instruction includes access control permission of the new user for the child file.

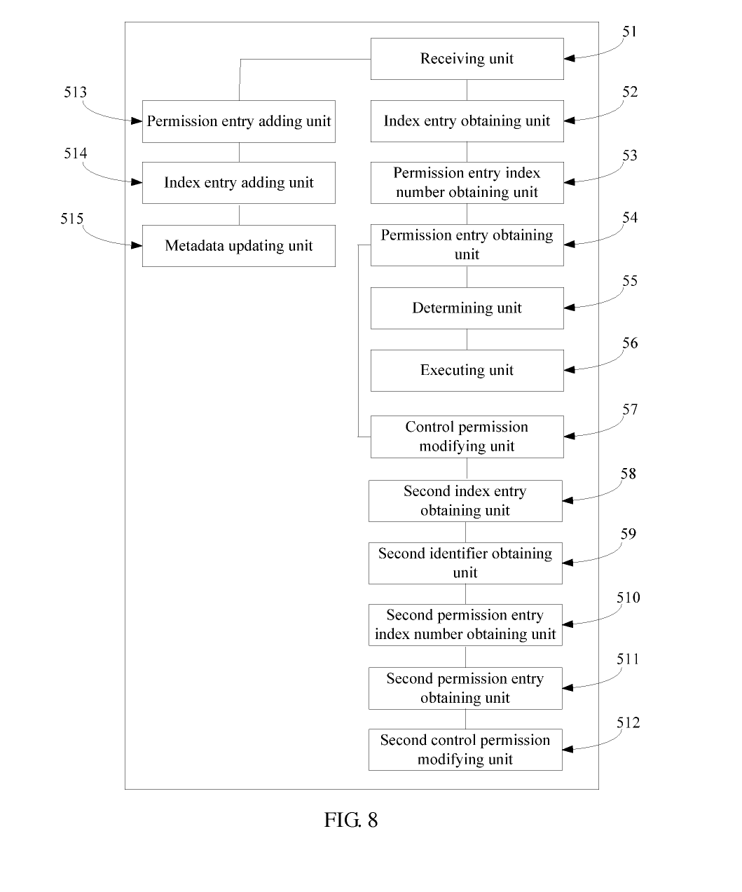

In addition, as shown in FIG. 8, the apparatus further includes a permission entry adding unit 513 configured to when the new user permission addition instruction is received, add a new permission entry in the permission table, where the new permission entry includes a new permission entry index number, the access control permission of the new user for the child file, and the new identifier of the user.

The index entry obtaining unit 52 is further configured to obtain the parent file index entry according to the parent file entry identifier.

The apparatus further includes an index entry adding unit 514 configured to create a new index entry in the index table, and record a new entry identifier, the new permission entry index number, and all permission entry index numbers recorded in the parent file index entry into the new index entry.

The apparatus further includes a metadata updating unit 515 configured to update metadata of the child file and the parent file with the new entry identifier, so that the new index entry is found according to the new entry identifier.

This embodiment of the present invention provides an access control permission management apparatus. When the control instruction for the target file is received from the user, the index entry pointed to by the entry identifier is obtained from the index table first, and then the target permission entry that records the access control permission for the target file is obtained from the permission table, and finally, whether execution of the control instruction is allowed is determined according to the access control permission in the target permission entry. Based on the foregoing solution, the index table and the permission table are used to manage access control permission information, which reduces complexity of managing the access control permission information in the memory and increases the system running speed if massive access control permission information exists in the memory.

In addition, when an access control permission modification instruction is received, the index entry pointed to by the entry identifier is obtained from the index table, and then, in the permission table, the access control permission in the target permission entry is found and modified. The access control permission is modified using the index table and the permission table, which reduces operation complexity of modifying the access control permission information in the memory. In addition, in a scenario where the user can use different operating systems to access files in the memory, when the permission of the permission entry of the target file is modified, all permission tables of different systems are modified, so as to ensure consistency of the access control permission for the target file when the same user accesses the same target file on different operating systems.

Further, when access control permission of a new user for a child file is added, a new permission entry is added in the permission table, a new index entry is added in the index table, and the entry identifier is changed so that the new index entry points to both the child file and the parent file. In this modification manner, if no inheritance relationship exists between the child file and the parent file any longer, the access control permission of their respective users can still be found according to the new index entry, which reduces the operation complexity and increases the system running speed in the process of adding user management permission information.

### Embodiment 4

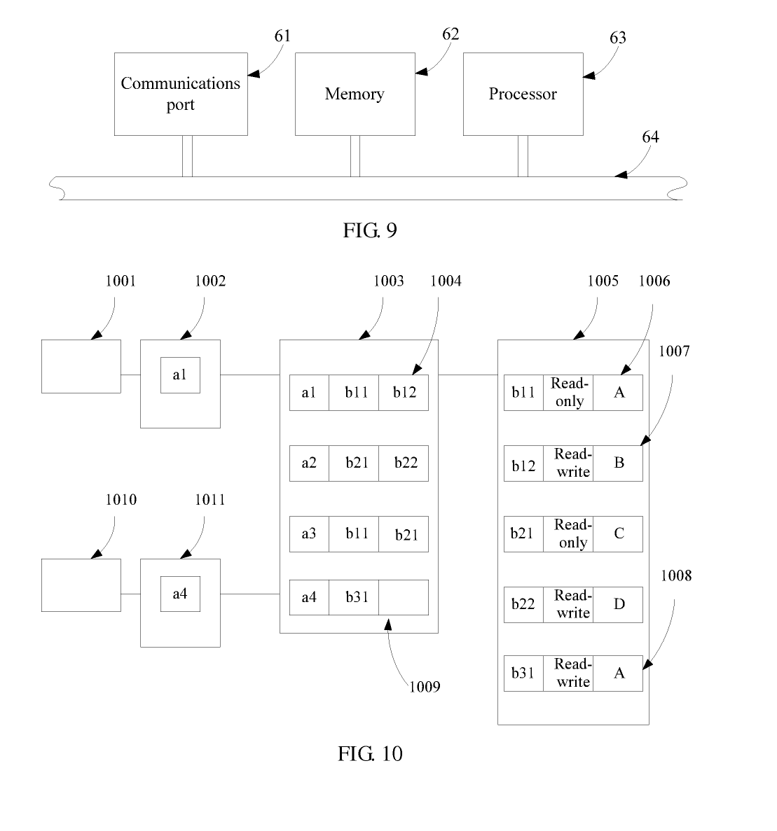

An embodiment of the present invention provides a storage device. As shown in FIG. 9, the device includes a communications port 61 configured to receive an identifier of a user, a target file identifier, and a control instruction of the user for a target file; a memory 62 configured to store an index table, a permission table, and code required when a processor 63 performs an operation, where each index entry in the index table records an entry identifier and at least one permission entry index number, and the entry identifier is generated by default in metadata of each newly generated file, so that the entry identifier points to the index entry corresponding to the file, where different permission entry index numbers in the same index entry are mapped to different permission entries in the permission table, each permission entry records a permission entry index number, access control permission for a file corresponding to the permission entry, and an identifier of a user that has the access control permission, and the different permission entries to which the different permission entry index numbers in the same index entry are mapped to record the access control permission for the same file; and the processor 63 configured to obtain the target file that has the target file identifier, obtain an entry identifier in metadata of the target file, and further obtain, from the index table of the memory 62, an index entry pointed to by the entry identifier in the metadata.

The processor 63 is further configured to obtain a target permission entry index number in the index entry pointed to by the entry identifier, where a permission entry pointed to by the target permission entry index number records access control permission for the target file; obtain, from the permission table according to the target permission entry index number, permission entries that record the access control permission for the target file, and select, from the obtained permission entries, a target permission entry that records the identifier of the user; and determine whether the control instruction is compliant with the access control permission recorded in the target permission entry, and when the control instruction is compliant, execute the control instruction.

The processor 63 is further configured to terminate the control instruction when the control instruction is not compliant with the access control permission recorded in the target permission entry.

The control instruction includes, but is not limited to, a read instruction, a write instruction, and an execute instruction.

Further, the communications port 61 is configured to receive an access control permission modification instruction of the user for the target file after receiving the identifier of the user, the target file identifier, and the control instruction of the user for the target file.

The processor 63 is further configured to when the communications port 61 receives the access control permission modification instruction, obtain the target file that has the target file identifier, obtain the entry identifier in the metadata of the target file, and further obtain, from the index table of the memory, the index entry pointed to by the entry identifier in the metadata; and then obtain, from the permission table according to the target permission entry index number, the permission entries that record the access control permission for the target file, and select, from the obtained permission entries, the target permission entry that records the identifier of the user; and the processor 63 is further configured to modify, according to the access control permission modification instruction, the access control permission recorded in the target permission entry for the target file.

The modifying, by the processor, the access control permission recorded in the target permission entry for the target file, includes deleting the access control permission of the user for the target file; or adding the access control permission of the user for the target file; when an existing access control permission needs to be modified, first performing an action of deleting the access control permission, and then adding a new access control permission in the location of the original access control permission, thereby modifying the existing access control permission.

Further, in an application scenario, the memory may exist on a NAS device or a file sharing server, and the user may use computers with different operating systems to access files in the memory. In this case, after the user modifies the access control permission for the target file in the memory using a first operating system, the modification needs to be synchronized to other operating systems except the first operating system. Otherwise, the result of the user modifying the access control permission for the target file using the first operating system does not take effect in other operating systems. On this basis, the processor 63 is further configured to obtain, according to a type of the first operating system, a first index table that matches the type of the first operating system, obtain the target file that has the target file identifier, obtain a first entry identifier in the metadata of the target file, and further obtain, from the first index table, a first index entry pointed to by the first entry identifier in the metadata.

The processor 63 is further configured to obtain a first target permission entry index number in the first index entry, where a first permission entry pointed to by the first target permission entry index number records first access control permission for the target file.

The processor 63 is further configured to obtain, from the first permission table according to the first target permission entry index number, first permission entries that record the first access control permission for the target file, and select, from the obtained first permission entries, a first target permission entry that records the identifier of the user.

The processor 63 is further configured to modify, according to the access control permission modification instruction, the first access control permission recorded in the first target permission entry for the target file.

Further, after modifying, according to the access control permission modification instruction, the first access control permission recorded in the first target permission entry for the target file, the processor 63 is further configured to obtain a second index table that matches a type of a second operating system, obtain a second entry identifier in the metadata of the target file, and further obtain, from the second index table, a second index entry pointed to by the second entry identifier in the metadata.

The processor 63 is further configured to obtain, from a preset user identifier conversion table, the second identifier of the user of the second operating system corresponding to the identifier of the user, where the user identifier conversion table records different identifiers of the same user on different types of operating systems.

The processor 63 is further configured to obtain a second target permission entry index number in the second index entry, where a second permission entry pointed to by the second target permission entry index number records second access control permission for the target file.

The processor 63 is further configured to obtain, from the second permission table according to the second target permission entry index number, second permission entries that record the second access control permission for the target file, and select, from the obtained second permission entries, a second target permission entry that records the second identifier of the user.

The processor 63 is further configured to modify, according to the access control permission modification instruction, the second access control permission recorded in the second target permission entry for the target file, so that the modified second access control permission is the same as the modified first access control permission.

For descriptions about the composition structure of the first index table, the first permission table, the second index table, and the second permission table, reference may be made to Embodiment 2 of the present invention, and the details are not described herein again.

Further, generally, when a new file is added in the computer, if the new file is located in a directory of an existing file, the existing file is a parent file of the new file, and the new file is a child file of the existing file. The child file can automatically inherit the access control permission for its parent file. In the embodiment of the present invention, when a child file is created in the directory of a parent file, the child file inherits a parent file entry identifier of its parent file. The parent file entry identifier points to a parent file index entry. In this way, the child file and the parent file use the same parent file entry identifier to point to the parent file index entry, so that the child file can inherit the access control permission for the parent file.

In this scenario, to manage the access control permission for the child file, the communications port 61 is further configured to receive a new user permission addition instruction and an identifier of a new user sent by a computer administrator for the child file. The new user permission addition instruction includes access control permission of the new user for the child file.

The processor 63 is further configured to add a new permission entry in the permission table when the communications port 61 receives the new user permission addition instruction, where the new permission entry includes a new permission entry index number, the access control permission of the new user for the child file, and the identifier of the new user.

The processor 63 is further configured to obtain the parent file index entry according to the parent file entry identifier.

The processor 63 is further configured to create a new index entry in the index table, and record a new entry identifier, the new permission entry index number, and all permission entry index numbers recorded in the parent file index entry into the new index entry.

The processor 63 is further configured to update metadata of the child file and the parent file with the new entry identifier, so that the new index entry is found according to the new entry identifier.

Further, the communications port 61, the memory 62, and the processor 63 are connected using a bus 64.

The embodiment of the present invention provides an access control permission management device. When the control instruction for the target file is received from the user, the target file is found first, and the entry identifier is obtained from metadata of the target file, and then the index entry pointed to by the entry identifier is obtained from the index table, and further, the target permission entry that records the access control permission for the target file is obtained from the permission table, and finally, whether execution of the control instruction is allowed is determined according to the access control permission in the target permission entry. Based on the foregoing solution, the index table and the permission table are used to manage access control permission information, which reduces complexity of managing the access control permission information in the memory and increases the system running speed if massive access control permission information exists in the memory.

In addition, when an access control permission modification instruction is received, the target file targeted at by the access control permission modification instruction is found, the entry identifier is obtained from the metadata of the target file, and then the corresponding index entry in the index table is found according to the entry identifier, and further, in the permission table, the access control permission in the target permission entry is found and modified. The access control permission is modified using the index table and the permission table, which reduces the operation complexity of modifying the access control permission information in the memory. In addition, in a scenario where the user can use different operating systems to access files in the memory, when the permission of the permission entry of the target file is modified, all permission tables of different systems are modified, so as to ensure consistency of the access control permission for the target file when the same user accesses the same target file on different operating systems.

Further, when access control permission of a new user for a child file is added, a new permission entry is added in the permission table, a new index entry is added in the index table, and the entry identifier is changed so that the new index entry points to both the child file and the parent file. In this modification manner, if no inheritance relationship exists between the child file and the parent file any longer, the access control permission of their respective users can still be found according to the new index entry, which reduces the operation complexity and increases the system running speed in the process of adding user management permission information.

According to the description of the foregoing embodiments, persons skilled in the art can clearly understand that the present invention may be implemented by software in addition to necessary universal hardware or by hardware only. In most circumstances, the former is preferred. Based on such an understanding, the technical solutions of the present invention in essence, or the parts that make contributions to the prior art, can be embodied in the form of a software product. The computer software product may be stored in a readable memory, for example, a floppy disk, a hard disk, or an optical disc in the computer, and may include several instructions used to instruct a computer device (for example, a personal computer, a server, or a network device) to perform the method specified in each embodiment of the present invention.

The foregoing descriptions are merely specific embodiments of the present invention, but are not intended to limit the protection scope of the present invention. Any variation or replacement figured out by a person skilled in the art within the technical scope disclosed in the present invention shall fall within the protection scope of the present invention. Therefore, the protection scope of the present invention shall be subject to the protection scope of the claims.

What is claimed is:

1. A method for a storage device accessing a file, wherein the storage device comprises a memory, and wherein the memory stores at least two tables, the method comprising:
receiving a control instruction of a target user for a target file, wherein the control instruction includes an identifier of the target user, an identifier of the target file and a control command;
acquiring an identifier of metadata stored in the memory by searching a map, wherein the map contains first data mapping the identifier of metadata to the identifier of the target file;
acquiring an index number by searching an index table, wherein the index table contains second data mapping the identifier of metadata to the index number;
acquiring one or more permission entries by searching a permission table, wherein the permission table contains third data mapping the index number to the permission entries, and wherein each of the permission entries contains an identifier of a user;
identifying a target permission entry which includes the identifier of the target user and a permission of the target user for the target file;
determining whether the control instruction is compliant with the permission of the target user for the target file; and
executing the control command to the target file when the control instruction is compliant with the permission of the target user for the target file.

2. The method according to claim 1, further comprising terminating the control command to the target file when the control instruction is not compliant with the permission of the target user for the target file.

3. The method according to claim 2, further comprising:
receiving a permission modification instruction of the target user for the target file, wherein the permission modification instruction includes the identifier of the target user, the identifier of the target file, and a modification command;
acquiring the identifier of metadata stored in the memory by searching the map, wherein the map contains the first data mapping the identifier of metadata to the identifier of the target file;
acquiring the index number by searching the index table, wherein the index table contains the second data mapping the identifier of metadata to the index number;
acquiring one or more permission entries by searching the permission table, wherein the permission table contains the third data mapping the index number to the permission entries, and wherein each of the permission entries contains the identifier of the target user;
identifying the target permission entry which includes the identifier of the target user; and
modifying the target permission entry according to the modification command.

4. The method according to claim 1, wherein the map corresponds to an Operation System (OS) stored in the storage device.

5. The method according to claim 1, wherein the storage device is a Network Attached Storage (NAS) device.

6. A storage device, comprising:
a communications port configured to receive a control instruction of a target user for a target file, wherein the control instruction includes an identifier of the target user, an identifier of the target file, and a control command;
a memory configured to store at least two tables;
a processor configured to:
acquire an identifier of metadata stored in the memory by searching a map, wherein the map contains first data mapping the identifier of metadata to the identifier of the target file;
acquire an index number by searching an index table, wherein the index table contains second data mapping the identifier of metadata to the index number;
acquire one or more permission entries by searching a permission table, wherein the permission table contains third data mapping the index number to the permission entries, and wherein each of the permission entries contains the identifier of the target user;
identify a target permission entry which includes the identifier of the target user and a permission of the target user for the target file;
determine whether the control instruction is compliant with the permission of the target user for the target file; and
execute the control command to the target file when the control instruction is compliant with the permission of the target user for the target file.

7. The device according to claim 6, wherein the processor is further configured to terminate the control command to the target file when the control instruction is not compliant with the permission of the target user for the target file.

8. The device according to claim 6, wherein the processor is further configured to:
receive a permission modification instruction of the target user for the target file, wherein the permission modification instruction includes the identifier of the target user, the identifier of the target file, and a modification command;
acquire the identifier of metadata stored in the memory by searching the map, wherein the map contains the first data mapping the identifier of metadata to the identifier of the target file;
acquire the index number by searching the index table, wherein the index table contains the second data mapping the identifier of metadata to the index number;
acquire one or more permission entries by searching the permission table, wherein the permission table contains the third data mapping the index number to the permission entries, and wherein each of the permission entries contains the identifier of the target user;
identify the target permission entry which includes the identifier of the target user; and
modify the target permission entry according to the modification command.

9. The device according to claim 6, wherein the map corresponds to an Operation System (OS) stored in the storage device.

10. The device according to claim 6, wherein the storage device is a Network Attached Storage (NAS) device.
